(19) United States
(12) Patent Application Publication
(10) Pub. No.: US 2026/0322253 A1
(43) Pub. Date: Oct. 15, 2026

(54) SOFT-START CONTROL METHOD FOR THREE-PHASE INTERLEAVED LLC RESONANT CONVERTER

(71) Applicant: STMicroelectronics International N.V., Geneva (CH)

(72) Inventors: Qi HUANG, Shanghai (CN); Ye HU, Taiwan (CN); Chengwei CHU, Taiwan (CN); Jianjun NI, Shanghai (CN); Runzhao YE, Guyangdong (CN)

(21) Appl. No.: 19/485,014

(22) PCT Filed: May 18, 2023
(86) PCT No.: PCT/CN2023/095156

§ 371 Date: Nov. 17, 2025

(51) Int. Cl. H02M 1/36; B60L 53/10; H02M 1/00; H02M 1/084; H02M 1/088; H02M 7/12; H02M 7/217

(52) U.S. Cl. CPC H02M 1/36; H02M 1/0043; H02M 1/084; H02M 1/088; H02M 7/125; H02M 7/2173; B60L 53/11; B60L 2210/30; B60L 2270/20

(57) ABSTRACT

Various embodiments of the present disclosure disclose various soft-start techniques for reliably starting a charging device, while reducing current spikes without modifications to duty cycles. The soft-start techniques may be implemented with a three-phase LLC resonant converter that includes a first carrier, a second carrier, and a third carrier. The soft-start techniques may include initializing a switch frequency and a phase angle for each of the carriers, increasing both the second and third carrier phase angles, then decreasing the second carrier phase angle and increasing the third carrier phase angle in response to the detection of a phase threshold, and in response to the detection of a start-up phase criteria, reducing a switch frequency for the three-phase resonant converter based on a target voltage.

### TECHNOLOGICAL FIELD

Example embodiments of the present disclosure relate generally to the field of direct current power conversion, and in particular, to systems and methods for implementing soft-start control of a three-phase LLC resonant converter.

### BACKGROUND

Applicant has identified many technical challenges and difficulties associated with resonant converters, such as three-phase LLC resonant converters. Through applied effort, ingenuity, and innovation, Applicant has solved problems related to resonant current spikes during start-up operations of resonant converters by developing solutions embodied in the present disclosure, which are described in detail below.

### BRIEF SUMMARY

Various embodiments described herein relate to systems, apparatuses, products, and methods for fragmented wideband tympanometry.

In some embodiments, a computing system includes a three-phase LLC resonant converter, the three-phase LLC resonant converter comprising a first carrier, a second carrier, and a third carrier; and a controller configured to initialize a switch frequency and a phase angle for each of the first carrier, the second carrier, and the third carrier; increase a second carrier phase angle for the second carrier; increase a third carrier phase angle for the third carrier; in response to a detection of a phase threshold, decrease the second carrier phase angle, and increase the third carrier phase angle; and in response to a detection of start-up phase criteria, reduce the switch frequency for the three-phase LLC resonant converter based on a target voltage.

In some embodiments, the three-phase LLC resonant converter is in a start-up control mode and the controller is further configured to monitor an output voltage of the three-phase LLC resonant converter; and in response to the detection of the target voltage based on the output voltage, transition the three-phase LLC resonant converter to a closed-loop control mode.

In some embodiments, the controller is further configured to initialize a duty cycle to fifty percent for each of the first carrier, the second carrier, and the third carrier.

In some embodiments, initializing the switch frequency for each of the first carrier, the second carrier, and the third carrier comprises setting the switch frequency to a maximum operable frequency for the three-phase LLC resonant converter.

In some embodiments, initializing the phase angle for each of the first carrier, the second carrier, and the third carrier comprises initializing a first carrier phase angle for the first carrier to zero degrees; initializing the second carrier phase angle for the second carrier to zero degrees; and initializing the third carrier phase angle for the third carrier to zero degrees.

In some embodiments, increasing the second carrier phase angle for the second carrier comprises increasing the second carrier phase angle at a first rate of change, and increasing the third carrier phase angle for the third carrier comprises increasing the third carrier phase angle at the first rate of change.

In some embodiments, decreasing the second carrier phase angle comprises decreasing the second carrier phase angle at a second rate of change, and increasing the third carrier phase angle comprises increasing the third carrier phase angle at the second rate of change.

In some embodiments, the phase threshold is one hundred and eighty degrees, and the controller is configured to monitor the second carrier phase angle and the third carrier phase angle; and detect the phase threshold in response to the second carrier phase angle and the third carrier phase angle achieving the phase threshold.

In some embodiments, the start-up phase criteria comprises a low phase threshold and a high phase threshold, and the controller is configured to monitor the second carrier phase angle and the third carrier phase angle; and detect the start-up phase criteria in response to the second carrier phase angle achieving the low phase threshold and the third carrier phase angle achieving the high phase threshold.

In some embodiments, the low phase threshold is one hundred and twenty degrees and the high phase threshold is two hundred and forty degrees.

In some embodiments, the computing system includes an electrical charging device configured to charge an external device and the target voltage is based on the external device.

In some embodiments, the external device is an electric vehicle battery.

In some embodiments, the target voltage is within a range of eight hundred and eight hundred and fifty volts.

In some embodiments, an electric charging device includes a three-phase LLC resonant converter, the three-phase LLC resonant converter comprising a first carrier, a second carrier, and a third carrier; and a controller configured to initialize a switch frequency and a phase angle for each of the first carrier, the second carrier, and the third carrier; increase a second carrier phase angle for the second carrier; increase a third carrier phase angle for the third carrier; in response to a detection of a phase threshold, decrease the second carrier phase angle, and increase the third carrier phase angle; and in response to a detection of start-up phase criteria, reduce the switch frequency for the three-phase LLC resonant converter based on a target voltage.

In some embodiments, the electric charging device is an electric vehicle charging pile.

In some embodiments, the three-phase LLC resonant converter is configured to convert alternating current power to direct current power for charging a vehicle battery.

In some embodiments, the vehicle battery is configured to receive an output voltage of at least eight hundred volts.

In some embodiments, a method includes initializing a switch frequency and a phase angle for each of a first carrier, a second carrier, and a third carrier of a three-phase LLC resonant converter; increasing a second carrier phase angle for the second carrier; increasing a third carrier phase angle for the third carrier; in response to a detection of a phase threshold, decreasing the second carrier phase angle, and increasing the third carrier phase angle; and in response to a detection of start-up phase criteria, reducing the switch frequency for the three-phase LLC resonant converter based on a target voltage.

In some embodiments, the method includes monitoring an output voltage of the three-phase LLC resonant converter; detecting the target voltage based on the output voltage; and in response to a detection of the target voltage, transitioning the three-phase LLC resonant converter from a start-up control mode to a closed-loop control mode.

In some embodiments, the target voltage is eight hundred volts.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF SUMMARY OF THE DRAWINGS

Having thus described certain example embodiments of the present disclosure in general terms, reference will now be made to the accompanying drawings, which are not necessarily drawn to scale, and wherein:

FIG. 1 illustrates an example computing entity in accordance with one or more embodiments of the present disclosure;

FIG. 2 illustrates an example computing apparatus configured with a resonant converter in accordance with one or more embodiments of the present disclosure;

FIG. 3 illustrates an example three-phase LLC resonant converter in accordance with one or more embodiments of the present disclosure;

FIG. 4 illustrates a flowchart of an example process for starting a resonant converter in accordance with one or more embodiments of the present disclosure;

FIG. 5 illustrates a flowchart of an example process for starting a resonant converter in accordance with one or more embodiments of the present disclosure;

FIG. 6 illustrates an operational example of carrier phase shifts in accordance with one or more embodiments of the present disclosure;

FIGS. 7A-B illustrate operational examples of operational parameters for one or more carriers of a resonant converter in accordance with one or more embodiments of the present disclosure; and

FIG. 8 illustrates an operational example of a waveform during start-up of a resonant converter in accordance with one or more embodiments of the present disclosure.

### DETAILED DESCRIPTION

Embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

Various example embodiments of the present disclosure are directed to improved systems, apparatuses, products, and methods for controlling resonant converters. The present disclosure, in some examples, describes a phase shifting and frequency decreasing mix soft-start control technique for a three-phase LLC resonant converter that suppresses the impact of starting current for the converter. By doing so, example techniques of the present disclosure address technical challenges related to resonant converters by eliminating harmful impacts from resonant current spikes related to the impedance and input voltage of resonant tanks. In this way, various embodiments of the present disclosure prevent damage to in-circuit power devices, while enabling the reliable, safe, and stable start-up of resonant converters.

LLC resonant converters may provide the advantages of high efficiency and high power density. For this reason, they have been widely used in power conversion equipment, such as battery chargers, and/or the like. LLC resonant converters may include single or three-phase topologies. Three-phase topologies may be used to reduce large output current ripples of single phase topologies. A three-phase interleaved LLC resonant converter may include a primary side with a three-phase inverter composed of one or more transistors (e.g., six metal-oxide-semiconductor field-effect transistor (MOSFET), etc.) and a secondary side that include at least one three-phase full-wave rectifier and/or two three-phase full-wave rectifiers. In some examples, a three-phase LLC topology may use a Y connection to realize the automatic adjustment of phase current and further reduce the output current ripples of single-phase topologies.

In some examples, the resonant frequency of a three-phase LLC resonant converter may be in the range of tens to hundreds of kilohertz. This may cause variables, such as voltage and current, to change rapidly within the resonant tank of the converter. The output of a three-phase LLC resonant converter may include a large capacitor for filtering, which may cause the dynamic of the output voltage to be slower than the resonant tank. During a start-up stage of the converter, the output voltage may be zero such that magnetic inductors of the converter may be considered a short-circuit state. The magnitude of a resonant current spike during start-up may be related to the impedance and the input voltage of the resonant tank. This may cause a large inrush current to be generated during a start-up stage that may destroy in-circuit power devices and have other detrimental impacts.

Traditionally, these technical challenges have been addressed using duty and/or frequency augmentation start-up methods.

For instance, frequency decreasing start-up methods, such as pulse frequency modulation techniques, take advantage of the principle that the impedance of a resonant tank increases with increasing frequency. The increase of resonant tank impedance may effectively reduce current spikes during startup. To do so, frequency decreasing start-up methods may set the duty cycle to a fixed ratio, such as 0.5, and the switch frequency to the maximum operating frequency available. Afterwards, the switch frequency may be gradually reduced until the output voltage reaches a minimum closed-loop voltage and the converter may enter a closed-loop control mode. While these techniques may be used to reduce current spikes during startup, they are impacted by different power devices and are not suitable for high voltage applications, such as vehicle charging applications in which output voltages may reach eight hundred volts or more. For instance, a switch frequency may not be indefinitely high and, when switching frequency increases to a certain range, the impedance increase of the resonant tank is not obvious. This leads to very large current spikes-up to seventy-five amps or more—at the moment of start-up.

As another example, in duty increasing and frequency decreasing start-up methods, such as pulse width modulation techniques, an equivalent input voltage of a resonant tank may be positively correlated with the duty. For example, a method may set a switch frequency to the maximum operating frequency available and a duty cycle to an initial ratio, such as 0.0. Afterwards, the duty may be gradually increased from the initial ratio to an operating ratio, such as 0.5. Once the operation ratio is achieved, the switch frequency may be gradually reduced until an output voltage reaches a minimum closed-loop voltage and the converter may enter a closed-loop control mode. While such techniques may address current spikes during start-up, they lead to power switches working in hard-switching states, which results in thermal stress, significant electromagnetic compatibility (EMC) interference, low product reliability, and various additional technical problems.

Some embodiments described herein improve upon traditional resonant converter start-up methods by implementing a phase-shift and frequency decreasing soft-start control method. In an initial stage, some of the techniques of the present disclosure may initialize a switch frequency, a phase angle, and/or a duty cycle for each carrier of a three-phase LLC resonant converter. At a second stage, a phase angle for two of the carriers may be gradually increased while one remains the same. Once a threshold phase angle is satisfied, the phase angle for a first of the two carriers may be increased, while the phase angle for a second of the two carriers may be decreased. When the phase angles for each of the first and second carriers reach second thresholds, respectively, a switch frequency may be reduced to increase an output voltage of the resonant converter to a target voltage. In this way, current spikes during startup may be reduced without causing power switches to work in hard-switching states among other benefits described herein.

It should be readily appreciated that the embodiments of the systems, apparatus, and methods described herein may be configured in various additional and alternative manners in addition to those expressly described herein.

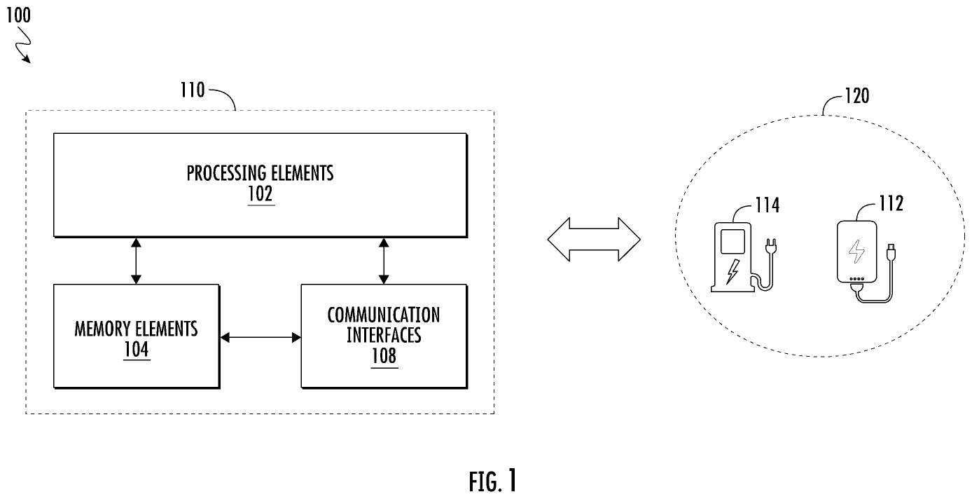

FIG. 1 illustrates an example computing system 100 in accordance with one or more embodiments of the present disclosure. In general, the terms computing system, computer, system, device, entity, and/or similar words used herein interchangeably may refer to, for example, one or more computers, computing entities, desktops, mobile phones, tablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably.

The computing system 100 may include a computing apparatus 110 and/or one or more computing entities 120 communicatively coupled to the computing apparatus 110 using one or more wired and/or wireless communication techniques. The computing apparatus 110 may include any computing device including, for example, a power converter (e.g., high voltage power converter, etc.) specially configured to perform one or more steps/operations of one or more soft start-up techniques described herein. In some embodiments, the computing apparatus 110 may include and/or be in association with one or more mobile device(s), desktop computer(s), laptop(s), server(s), cloud computing platform(s), and/or the like. In some example embodiments, the computing apparatus 110 may be configured to receive and/or provide power conversion instructions, data, and/or the like between the one or more computing entities 120 to perform one or more steps/operations of one or more soft start-up techniques described herein.

In some embodiments, the computing apparatus 110 includes, is integrated with, and/or is otherwise in association with a power charging device. For example, the computing apparatus 110 may be configured to receive and/or provide one or more power conversion instructions between one or more components of the one or more computing entities 120. The computing entities 120, for example, may include and/or be associated with one or more charging systems. The one or more charging systems, for example, may include one or more external battery systems 112, charging piles 114, and/or any other power charging system configured to provide a direct current to charge external devices. By way of example, the power charging systems may include electric vehicle charging piles, such as direct current charging piles with high voltage and high current conversion applications. According to some embodiments, the computing apparatus 110 may include a charging device of the computing entities 120 that is configured to receive an alternating current and convert the alternative current to a direct current voltage for charging an external device, such as an electric vehicle, and/or the like.

The computing apparatus 110 can include, or be in communication with, one or more processing elements 102 (also referred to as processors, processing circuitry, digital circuitry, and/or similar terms used herein interchangeably) that communicate with other elements within the computing apparatus 110 via a bus, for example. As will be understood, the processing element 102 can be embodied in a number of different ways.

For example, the processing element 102 can be embodied as one or more complex programmable logic devices (CPLDs), microprocessors, multi-core processors, coprocessing entities, application-specific instruction-set processors (ASIPs), microcontrollers, and/or controllers. Further, the processing element 102 can be embodied as one or more other processing devices or circuitry. The term circuitry can refer to an entirely hardware embodiment or a combination of hardware and computer program products. Thus, the processing element 102 can be embodied as integrated circuits, application specific integrated circuits (ASICs), field programmable gate arrays (FPGAs), programmable logic arrays (PLAs), hardware accelerators, digital circuitry, and/or the like.

As will therefore be understood, the processing element 102 can be configured for a particular use or configured to execute instructions stored in volatile or non-volatile media or otherwise accessible to the processing element 102. As such, whether configured by hardware or computer program products, or by a combination thereof, the processing element 102 can be capable of performing steps or operations according to embodiments of the present disclosure when configured accordingly.

In one embodiment, the computing apparatus 110 can further include, or be in communication with, one or more memory elements 104. The one or more memory elements 104 can include non-volatile and/or volatile media. The memory elements 104, for example, can include non-volatile media (also referred to as non-volatile storage, memory, memory storage, memory circuitry and/or similar terms used herein interchangeably). In one embodiment, the non-volatile storage or memory can include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media can store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably can refer to a collection of records or data that is stored in a computer-readable storage medium using one or more database models, such as a hierarchical database model, network model, relational model, entity-relationship model, object model, document model, semantic model, graph model, and/or the like.

In addition, or alternatively, the memory elements 104 can include volatile memory. For example, the computing apparatus 110 can further include, or be in communication with, volatile media (also referred to as volatile storage memory, memory storage, memory circuitry and/or similar terms used herein interchangeably). In one embodiment, the volatile storage or memory can also include one or more volatile storage or memory media, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media can be used to store at least portions of the databases, database instances, database management systems, data, applications, programs, program modules, scripts, source code, object code, byte code, compiled code, interpreted code, machine code, executable instructions, and/or the like being executed by, for example, the processing element 102. Thus, the databases, database instances, database management systems, data, applications, programs, program modules, scripts, source code, object code, byte code, compiled code, interpreted code, machine code, executable instructions, and/or the like can be used to control certain aspects of the operation of the computing apparatus 110 with the assistance of the processing element 102 and operating system.

As indicated, in one embodiment, the computing apparatus 110 can also include one or more communication interfaces 108 for communicating with various computing entities, including computing entities 120, such as by communicating data, content, information, and/or similar terms used herein interchangeably that can be transmitted, received, operated on, processed, displayed, stored, and/or the like. The one or more communication interfaces 108, for example, can include one or more wired peripherals (e.g., fiber interfaces, ethernet ports, and/or the like), antenna, transmitters, receivers, digital to analog converters (DAC), analog to digital converters (ADC), modulators, demodulators, and/or the like. Such communication can be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing apparatus 110 can be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, NFC protocols such as NFC-A, NFC-B, NFC-F, Wibree, Bluetooth protocols, wireless universal serial bus (USB) protocols, and/or any other wireless protocol.

The computing apparatus 110 can include input/output circuitry for communicating with one or more users. The input/output circuitry, for example, can include one or more user interfaces for providing and/or receiving information from one or more users of the computing apparatus 110. The input/output interfaces can include one or more tactile interfaces (e.g., keypads, touch screens, etc.), one or more audio interfaces (e.g., microphones, speakers, etc.), visual interfaces (e.g., display devices, etc.), and/or the like. The input/output circuitry can be configured to receive user input through one or more of the user interfaces from a user of computing apparatus 110 and provide data to a user through the one or more of the user interfaces.

Example embodiments of the present disclosure describe a specific rules-based start-up framework for starting up a charging operation, for example, to increase a charge level of an external device. The start-up framework defines specific rules-based techniques to reliably perform a start-up operation for high-voltage systems that reduces current spikes during startup, without causing power switches to work in hard-switching states among other benefits described herein.

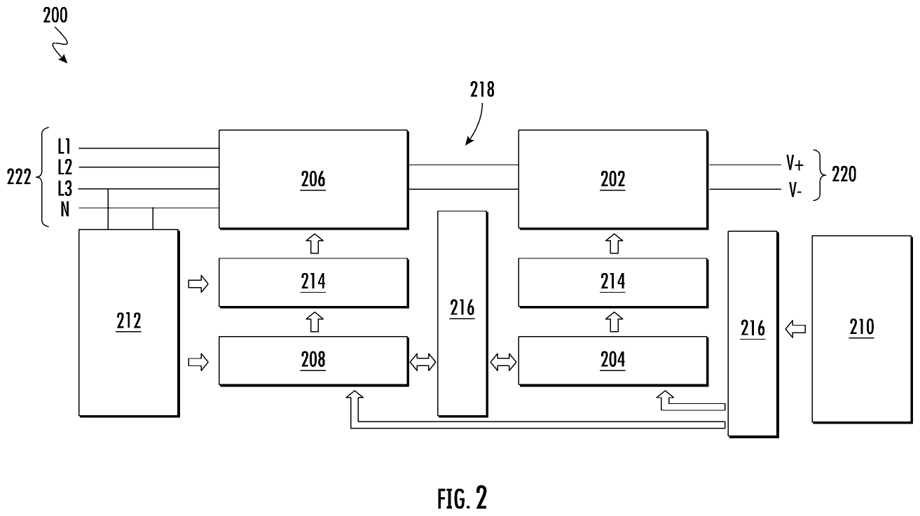

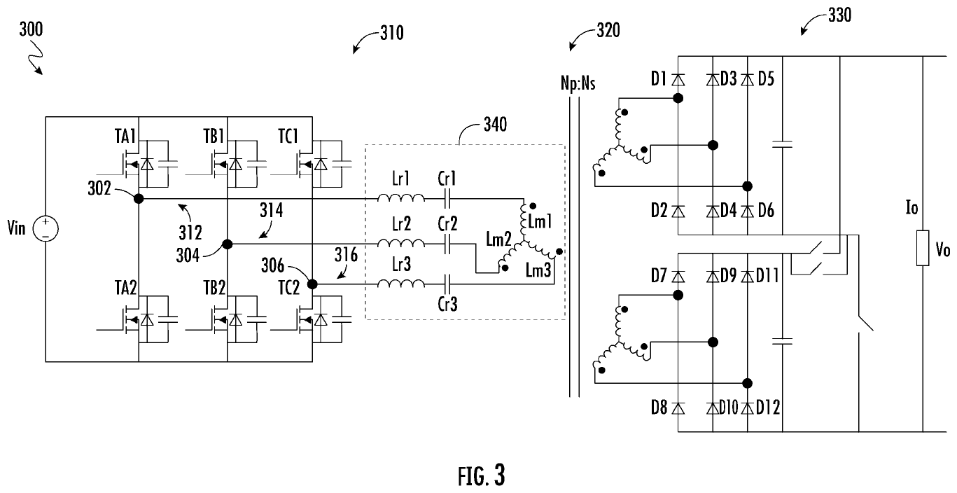

FIG. 2 illustrates an example computing apparatus 200 configured with a resonant converter in accordance with one or more embodiments of the present disclosure. The computing apparatus 200 may include and/or be a part of an electric charging device. The electric charging device, for example, may include a direct current charging device, such as a direct current charging pile for an electric vehicle. By way of example, the computing apparatus 200 may include and/or be a part of an electric vehicle charging pile. For example, the resonant converter 202 may be configured to convert alternating current power to direct current power for charging any power storage device including, as examples, a remote battery, an electric vehicle battery, and/or the like.

In some embodiments, the computing apparatus 200 is specially configured to enable reliable high voltage charging (e.g., fast charging) for high capacity power storage devices, such as electric vehicle batteries. For example, an electric vehicle battery may be configured to receive an output voltage 220 from a charging pile that is within an extended range of eight hundred to eight hundred and fifty volts. The computing apparatus 200 may be specially configured to enable an output voltage 220 from a charging pile that at least eight hundred and fifty volts or more.

In some embodiments, the computing apparatus 200 includes a resonant converter 202, a resonant controller 204, power factor correction (PFC) 206, a PFC controller 208, an outlet controller 210, an auxiliary flyback 212, and/or any other electrical component configured to facilitate an electrical power transfer. Each of the components may be communicatively coupled through one or more isolated gate drivers 214 and/or other isolated communication channels 216. The PFC 206 and resonant converter 202 may be coupled through a direct current link 218.

In some embodiments, the resonant converter 202 includes any type of electric power converter that leverages a resonant tank. For example, the resonant converter 202 may include a series resonant converter, a parallel resonant converter, and/or the like. In some examples, the resonant converter 202 may include a single phase resonant converter, a three-phase resonant converter, and/or the like. By way of example, the resonant converter 202 may include a three-phase LLC resonant converter that includes a first carrier, a second carrier, and/or a third carrier.

In some embodiments, the computing apparatus 200 includes a resonant controller 204 that is configured to control one or more parameters of the resonant converter 202. The resonant controller 204, for example, may include an integrated circuit, such as a microcontroller unit, that is configured to control one or more gates, switches, drivers, carriers, and/or any other electrical component of the resonant converter 202 to initiate a modification of one or more parameters of the resonant converter 202. By way of example, the one or more parameters may include one or more switch frequencies, phase angles, duty cycles, and/or the like.

The resonant controller 204 may include an embedded design, programmable logic, and/or the like for performing one or more operations of a soft-start method, such as the soft-start method of the present disclosure. By way of example, the resonant controller 204 may be configured (e.g., designed, programmed, etc.) to initialize a switch frequency and a phase angle for each of a first carrier, a second carrier, and/or a third carrier of the resonant converter 202, increase a second carrier phase angle for the second carrier and a third carrier phase angle for the third carrier, in response to the detection of a phase threshold, decrease the second carrier phase angle and increase the third carrier phase angle, and in response to the detection of start-up phase criteria, reduce the switch frequency for the resonant converter based on a target voltage.

The resonant controller 204 may be based on the resonant converter 202. For example, in the event that the resonant converter 202 is an LLC resonant converter, the resonant controller 204 may include an LLC microcontroller unit.

The PFC 206 may include an integrated circuit of the computing apparatus 200 that is configured to compensate for a lagging current between one or more electrical supply lines 222, for example, by creating a leading current by coupling capacitors to the supply. The PFC controller 208 may include an integrated circuit, such as a microcontroller unit, that is configured to control one or more gates, switches, drivers, carriers, and/or any other electrical component of the PFC 206.

The outlet controller 210 may include an electrical component, such as a switch, and/or the like, that is configured to control the operation of the computing apparatus 200. By way of example, the outlet controller 210 may be configured to transition the computing apparatus 200 between states, such as a charging (“ON”) state, a non-charging (“OFF”) state, and/or the like. The auxiliary flyback 212 may include a flyback converter that is configured to suppress voltage ripples of the computing apparatus 200 among other operations.

As described herein, the computing apparatus 200 may include a resonant converter 202 of any type that is configured to translate an alternating current to a direct current for charging an external device, such as an external battery, vehicle battery, and/or the like. One example resonant converter 202 may include a three-phase LLC resonant converter that may be susceptible to resonant current spikes during start-up operations. An example three-phase LLC resonant converter is described in more detail with reference to FIG. 3.

FIG. 3 illustrates an example three-phase LLC resonant converter 300 in accordance with one or more embodiments of the present disclosure. The three-phase LLC resonant converter 300 may include a primary side 310, a secondary side 330, and a transformer 320. The primary side 310 may include a three-phase inverter composed of six MOSFETs. In some examples, in order to reduce an output current ripple of the converter, the switch drivers of the three-phase inverter may work in an interleaving one hundred and twenty degree mode.

In some embodiments, the three-phase LLC resonant converter 300 includes a plurality of carriers. For instance, the three-phase LLC resonant converter 300 may include a first carrier 302, a second carrier 304, a third carrier 306, and/or the like. In some examples, the carriers may be configured on a primary side 310 of the three-phase LLC resonant converter 300. For instance, the three carriers may be formed by the six MOSFETs of the primary side 310. As described herein, each carrier may be controlled to operate according to one or more different carrier parameters, such as frequency, phase angle, duty cycle, and/or the like. For example, the first carrier 302 may be configured to operate at a first carrier phase angle 312, the second carrier 304 may be configured to operate at a second carrier phase angle 314, and/or the third carrier 306 may be configured to operate at a third carrier phase angle 316.

In some embodiments, the primary side 310 includes a three-phase inverter bridge that couples the first carrier 302, the second carrier 304, and the third carrier 306 to a resonant tank 340. For example, the primary side 310 may include a resonant tank 340. The resonant tank 340 may include an LLC resonant tank. The LLC resonant tank may be composed of a resonant inductor (e.g., Lr1, Lr2, Lr3, etc.), a resonant capacitor (e.g., Cr1, Cr2, Cr3, etc.), and/or a magnetic inductor (e.g., Lm1, Lm2, Lm3) of a transformer.

In some embodiments, the secondary side 330 includes one or more three-phase rectifiers. For example, the secondary side 330 may include one three-phase and/or two three-phase rectifiers. In the event that the secondary side 330 includes two rectifiers, the two rectifiers may be coupled in parallel (e.g., in a parallel resonant converter topology, etc.) or in series (e.g., in a series resonant converter topology, etc.) to meet different voltage and/or current standards. The three-phase LLC resonant converter 300 illustrated by FIG. 3 includes a parallel topology for example purposes only.

In some embodiments, the three-phase LLC resonant converter 300 may use a Y connection to realize an automatic adjustment of the phase current and/or reduce an output current ripple.

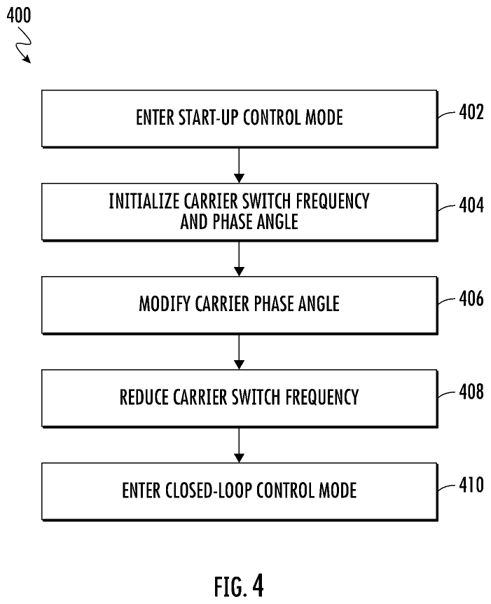

The three-phase LLC resonant converter 300 may include one of a plurality of different application topologies for which some of the techniques of the present disclosure may be implemented. The techniques of the present disclosure may be implemented in any three-phase topology and is not limited to the three-phase LLC resonant converter 300. In some embodiments, resonant converters, such as the three-phase LLC resonant converter 300, may be susceptible to resonant current spikes during start-up operations that may be detrimental to the short-term and/or operational lifetime of the converter or a computing apparatus within which the converter resides. Resonant current spikes may be reduced using soft-start control methods, such as one or more of the methods described herein. An example soft-start control process is described in more detail with reference to FIG. 4.

FIG. 4 illustrates a flowchart of an example process 400 for starting a resonant converter in accordance with one or more embodiments of the present disclosure. The flowchart depicts soft-start control techniques to overcome various limitations of traditional resonant converters. The soft-start control techniques may be implemented by one or more computing devices, entities, and/or systems described herein. For example, via the various steps/operations of the process 400, a controller, such as a resonant controller described herein, may leverage the soft-start control techniques to overcome the various limitations with traditional resonant converters by implementing a phase shifting and frequency decreasing mix soft-start control method. By way of example, the process 400 may include a phase-shift and frequency decreasing mix soft-start control method for a three-phase resonant LLC converter, which suppresses the impact of starting current and enables the converter to start safely and stably.

FIG. 4 illustrates an example process 400 for explanatory purposes. Although the example process 400 depicts a particular sequence of steps/operations, the sequence may be altered without departing from the scope of the present disclosure. For example, some of the steps/operations depicted may be performed in parallel or in a different sequence that does not materially impact the function of the process 400. In other examples, different components of an example device or system that implements the process 400 may perform functions at substantially the same time or in a specific sequence.

According to some examples, the process 400 includes, at step/operation 402 entering a start-up control mode. For example, the controller may cause a resonant converter to enter the start-up mode. The start-up mode, for example, may be initiated for an electric charging device to prepare the device for one or more charging operations. During the start-up mode, the electric charging device may gradually increase a voltage output over time to reach a target voltage output that may be handled by an external device, without causing detrimental impacts to the electrical components of the electric charging device, the external device, or the resonant converter.

According to some examples, the process 400 includes, at step/operation 404 initializing a carrier parameters for the resonant converter. For example, the resonant converter may include a three-phase LLC resonant converter that includes a first carrier, a second carrier, and/or a third carrier. The controller may initialize a switch frequency, a phase angle, and/or a duty cycle for each of the first carrier, the second carrier, and/or the third carrier.

In some examples, the controller may initialize the frequency for each of the carriers to a maximum allowable frequency of the resonant converter. For example, the controller may initialize the first switch frequency for the first carrier to a maximum operable frequency for the first carrier, a second switch frequency for the second carrier to a maximum operable frequency for the second carrier, and/or a third switch frequency for the third carrier to a maximum operable frequency for the third carrier. The maximum operable frequency may include a switching frequency that substantially equals the highest resonant frequency achievable by the resonant converter. The maximum operable frequency may be based on the resonant converter. As one example, if the magnetic inductor does not participate in resonance, the resonance frequency for a resonant converter may be expressed as:

$${f}_{r} = \frac{1}{2 π \sqrt{{L}_{r} {C}_{r}}} .$$

As another example, if the magnetic inductor does participate in the resonance, the resonance frequency for a resonant converter may be expressed as:

$${f}_{m} = \frac{1}{2 π \sqrt{( {L}_{r} + {L}_{m} ) {C}_{r}}} .$$

In some examples, the switching frequency, fₛ, may be equal to the resonance frequency.

In some examples, the magnitude of a starting resonant current spike is related to an impedance and input voltage of the resonant tank. The magnitude of the starting resonant current spike may be equal to the equivalent input voltage divided by the impedance of the resonant tank. By setting the switch frequency to the maximum operating frequency of the resonant converter, some examples of the present disclosure obtain a maximum impedance of the resonant tank.

In some examples, the controller may initialize a duty cycle for each of the first carrier, the second carrier, and the third carrier. In some examples, the controller may initialize the duty cycle to a ratio or 0.5, or fifty percent, for each of the first carrier, the second carrier, and/or the third carrier.

In some examples, the controller may initialize the phase angle for each of the carriers to zero. For example, the controller may initialize a first carrier phase angle for the first carrier to zero degrees, the second carrier phase angle for the second carrier to zero degrees, and/or the third carrier phase angle for the third carrier to zero degrees.

By way of example, θ₁, θ₂, θ₃ may respectively represent the phase angles of the carriers A, B, C of the resonant converter. In an initial stage of the start-up mode, the controller may set the duty to a fixed 0.5 (e.g., including dead time), the switch frequency to the maximum operating frequency, the initial value of θ₁ to 0°, and the initial values of θ₂ and θ₃>=0. θ₂ and θ₃ may be as small as possible to obtain a smaller equivalent input voltage of the resonant tank of the resonant converter.

According to some examples, the process 400 includes, at step/operation 406 modifying a carrier phase angle for one or more of the carriers of the resonant converter. For example, the controller may increase a second carrier phase angle, θ₂, for the second carrier and/or the third carrier phase angle, θ₃, for the third carrier. In some examples, the second carrier phase angle and the third carrier phase angle may be increased at substantially the same rate. For example, the controller may increase the second carrier phase angle for the second carrier by increasing the second carrier phase angle at a first rate of change. In addition, or alternatively, the controller may increase the third carrier phase angle for the third carrier by increasing the third carrier phase angle at the first rate of change. In some examples, the second carrier phase angle, θ₂, and the third carrier phase angle, θ₃, may slowly lag the first carrier phase angle, θ₁, with a same fixed speed until θ₂ and θ₃ reach a phase threshold (e.g., 180°). Meanwhile, θ₂ may substantially equal θ₃.

In some embodiments, the controller monitors the second and third carrier phase angle to detect the phase threshold. For example, the controller may monitor the second carrier phase angle and the third carrier phase angle to track the phase angles as they are increased. By way of example, the phase threshold may be one hundred and eighty degrees. In some examples, the controller may detect the phase threshold in response to both the second carrier phase angle and the third carrier phase angle achieving one hundred and eighty degrees. In response to the detection of the phase threshold, the controller may decrease the second carrier phase angle and/or increase the third carrier phase angle. By way of example, the controller may decrease the second carrier phase angle by decreasing the second carrier phase angle at a second rate of change. In addition, or alternatively, the increasing the third carrier phase angle by increasing the third carrier phase angle at a rate of change that is substantially the same as the second rate of change. For example, the second and third carrier phase angles may be gradually decreased and/or increased, respectively, at the same rate of change.

In some embodiments, the second and third carrier phase angles are modified until start-up phase criteria for the carriers is identified. The start-up phase criteria may define one or more phase thresholds for each of the carriers of the resonant converter. For instance, the start-up phase criteria may include a low phase threshold and/or a high phase threshold. In some examples, the low phase threshold may include one hundred and twenty degrees. In some examples, the high phase threshold may include two hundred and forty degrees. In some embodiments, the controller monitors the second carrier phase angle and/or the third carrier phase angle to detect the start-up phase criteria. For example, the controller may detect the start-up phase criteria in response to the second carrier phase angle achieving the low phase threshold and/or the third carrier phase angle achieving the high phase threshold. For example, the θ₂ gradually decreases until θ₂=120° and the θ₃ gradually increases until θ₃=240°.

According to some examples, the process 400 includes, at step/operation 408 reducing a carrier switch frequency. For example, in response to the detection of the second phase thresholds, the controller may reduce the switch frequency for the three-phase resonant converter based on a target voltage. By way of example, the controller may reduce the switch frequency for each of the first carrier, the second carrier, and the third carrier in response to the detection of a second phase threshold. In some examples, the controller may reduce the switch frequency with an appropriate speed so that an output voltage reaches a target voltage.

In some embodiments, the target voltage is based on an external device. For example, the three-phase LLC resonant converter and/or the controller may be included in a computing system that includes an electrical charging device. The electrical charging device may be configured to charge an external device based on a target voltage for the external device. By way of example, the external device may include a high voltage system, such as an electric vehicle battery. In some examples, the target voltage may be within a range of eight hundred and eight hundred and fifty volts, for example, to charge an electric vehicle battery. In some examples, the three-phase LLC resonant converter may be configured to receive an input voltage within a range of eight hundred to eight hundred and fifty volts to charge the external device.

According to some examples, the process 400 includes, at step/operation 410 entering a closed-loop control model. For example, the three-phase LLC resonant converter may be in a start-up control mode. The controller may monitor the output voltage of the three-phase LLC resonant converter as the switching frequency is reduced. In response to the detection of the target voltage based on the output voltage, the controller may transition the three-phase LLC resonant converter to a closed-loop control mode for performing one or more charging operations for the external device.

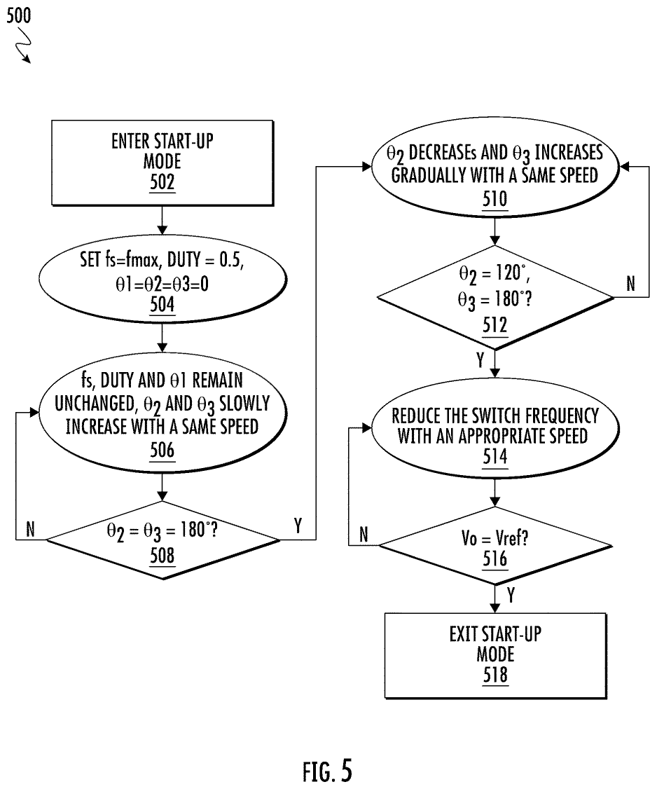

In some embodiments, the process 400 includes a specific sequence of operations for transitioning the resonant converter from a start-up mode to the closed-loop control mode. For instance, an example sequence of operations is described in more detail with reference to FIG. 5.

FIG. 5 illustrates a flowchart of an example process 500 for starting a resonant converter in accordance with one or more embodiments of the present disclosure. The flowchart depicts soft-start control techniques to overcome various limitations of traditional resonant converters. The soft-start control techniques may be implemented by one or more computing devices, entities, and/or systems described herein. For example, via the various steps/operations of the process 500, a controller, such as a resonant controller described herein, may leverage the soft-start control techniques to overcome the various limitations with traditional resonant converters by implementing a phase shifting and frequency decreasing mix soft-start control method.

FIG. 5 illustrates an example process 500 for explanatory purposes. Although the example process 500 depicts a particular sequence of steps/operations, the sequence may be altered without departing from the scope of the present disclosure. For example, some of the steps/operations depicted may be performed in parallel or in a different sequence that does not materially impact the function of the process 500. In other examples, different components of an example device or system that implements the process 500 may perform functions at substantially the same time or in a specific sequence.

According to some examples, the process 500 includes, at step/operation 502, entering a start-up control mode. For example, the controller may cause a resonant converter to enter the start-up mode as described with reference to step/operation 402 of process 400.

According to some examples, the process 500 includes, at step/operation 504, initializing one or more carrier parameters for the resonant converter. For example, the controller may initialize the switching frequency, fₛ, to fₛ=fₘₐₓ, the duty=0.5, and the phase angles θ₁=θ₂=θ₃=0.

According to some examples, the process 500 includes, at step/operation 506 increasing the phase angle of the second and third carrier of the resonant converter. For example, fs, duty, and θ1 may remain unchanged, while θ₂ and θ₃ slowly increase with a same speed.

According to some examples, the process 500 includes, at step/operation 508, monitoring the phase angle of the second and third carrier of the resonant converter. For example, the phase angles may be monitored to detect whether θ₂=θ₃=180°. In the event that the phase angles do not equal 180°, the second and third phase angles may be gradually increased. In the event that the phase angle of the second carrier and the third carrier do equal 180°, the process 500 may proceed to step/operation 510.

According to some examples, the process 500 includes, at step/operation 510, modifying the phase angle of the second and third carrier by increasing the phase angle of the first carrier and decreasing the phase angle of the second carrier. For example, θ₂ may decrease, while θ₃ may increase gradually with a same speed.

According to some examples, the process 500 includes, at step/operation 512 monitoring the phase angle of the second and third carrier of the resonant converter. For example, the phase angles may be monitored to detect whether θ₂=120° and/or θ₃=240° In the event that the phase angles do not equal 120° and/or 240%, respectively, θ₂ may be gradually decreased, while θ₃ may be gradually increased. In the event that θ₂=120° and/or θ₃=240°, the process 500 may proceed to step/operation 514.

According to some examples, the process 500 includes, at step/operation 514, reducing the switch frequency of the resonant converter to achieve a target output voltage. For example, the switch frequency may be reduced with an appropriate speed.

According to some examples, the process 500 includes, at step/operation 516, monitoring the output voltage of the resonant converter. For example, the output voltage may be monitored to detect whether the output voltage (e.g., Vo) equals a target voltage (e.g., Vref). In the event that the Vo!=Vref, the switch frequency of the resonant converter may be gradually reduced. In the event that the Vo=Vref, the process 500 may proceed to step/operation 520.

According to some examples, the process 500 includes, at step/operation 518, exiting the start-up mode. For example, the start-up mode may be completed and the resonant converter may enter a closed-loop control mode.

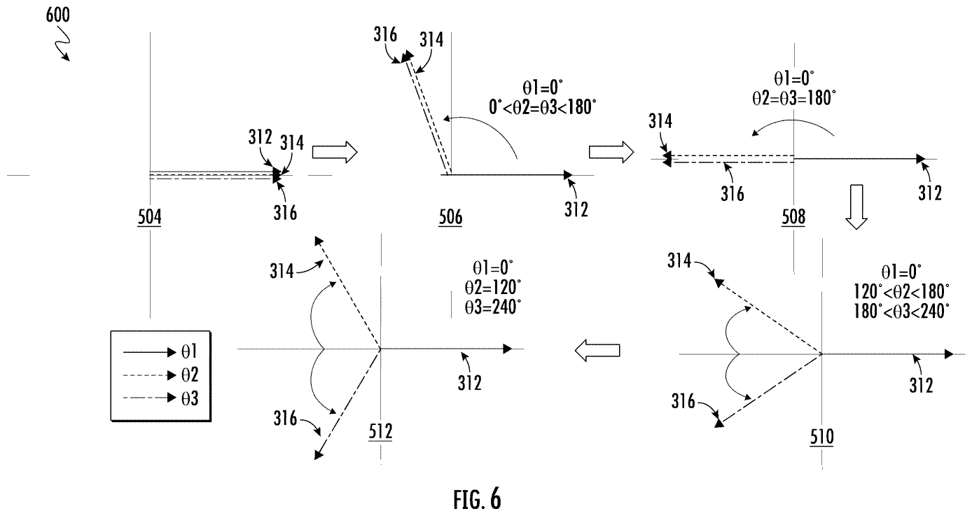

As described herein, one or more of the steps/operations of the process 500 may include modifying a phase angle of one or more carriers of the resonant converter. An example sequence of phase angle modifications is described in more detail with reference to FIG. 6.

FIG. 6 illustrates an operational example 600 of carrier phase shifts in accordance with one or more embodiments of the present disclosure. As shown, at step/operation 504, the first carrier phase angle 312, the second carrier phase angle 314, and/or the third carrier phase angle 316 may be set to zero degrees. At step/operation 506, the first carrier phase angle 312 may remain at zero degrees and the second carrier phase angle 314 and/or the third carrier phase angle 316 may be gradually increased. At step/operation 508, the first carrier phase angle 312 may remain at zero degrees and the second carrier phase angle 314 and/or the third carrier phase angle 316 may reach one hundred and eighty degrees. At step/operation 510, the first carrier phase angle 312 may remain at zero degrees, the second carrier phase angle 314 may be gradually decreased from one hundred and eight degrees, and/or the third carrier phase angle 316 may be gradually increased from one hundred and eighty degrees. At step/operation 512, the first carrier phase angle 312 may remain at zero degrees, the second carrier phase angle 314 may reach one hundred and twenty degrees, and/or the third carrier phase angle 316 may reach two hundred and forty degrees.

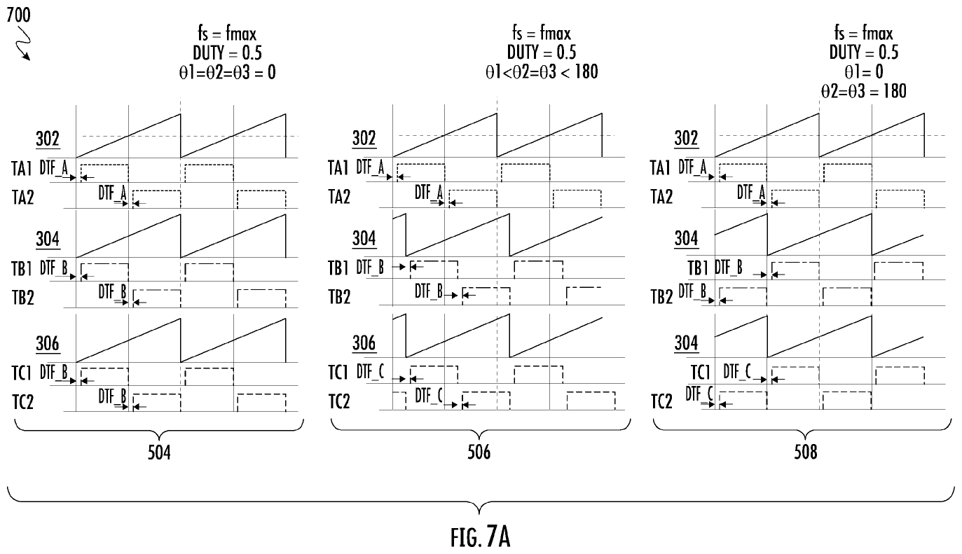

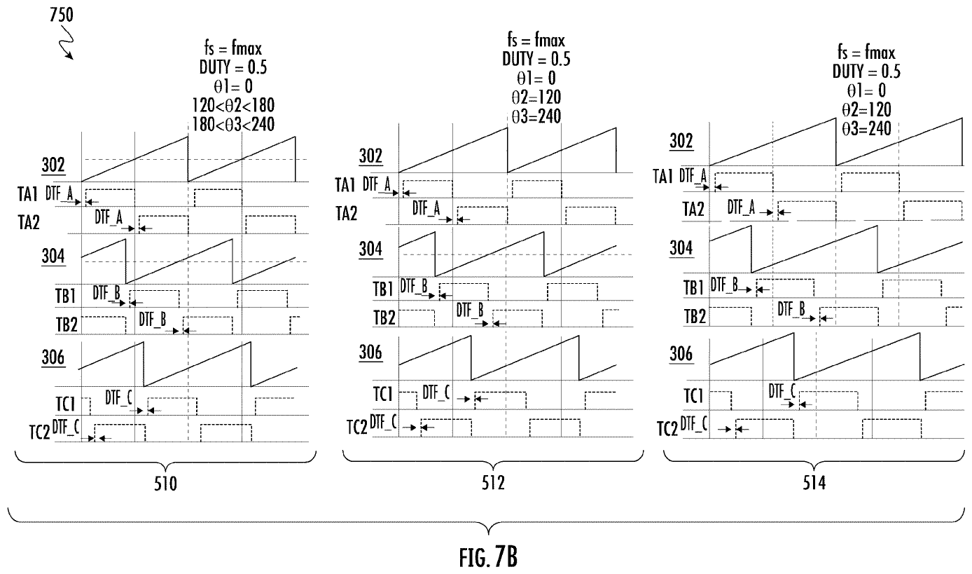

FIGS. 7A-B illustrate operational examples of operational parameters for one or more carriers of a resonant converter in accordance with one or more embodiments of the present disclosure. FIG. 7A illustrates an operational example 700 of operational parameters during one or more initial stages (e.g., steps/operations 504 to 508) of a start-up process. FIG. 7B illustrates an operational example 750 of operational parameters during one or more second stages (e.g., steps/operations 510 to 514) of the start-up process.

For example, with reference to FIG. 7A, at step/operation 504, the switch frequency may be set to fmax, the duty may be set to 0.5, and the phase angle may be set to 0 for the first carrier 302, the second carrier 304, and/or the third carrier 306.

At step/operation 506, the switch frequency may be set to fmax and the duty may be set to 0.5 for the first carrier 302, the second carrier 304, and/or the third carrier 306. The phase angle may be set to 0 for the first carrier 302 and the phase angles for the second carrier 304 and the third carrier 306 may be less than 180°.

At step/operation 508, the switch frequency may be set to fmax and the duty may be set to 0.5 for the first carrier 302, the second carrier 304, and/or the third carrier 306. The phase angle may be set to 0 for the first carrier 302 and the phase angles for the second carrier 304 and the third carrier 306 may be equal to 180°.

Turning to FIG. 7B, at step/operation 510, the switch frequency may be set to fmax and the duty may be set to 0.5 for the first carrier 302, the second carrier 304, and/or the third carrier 306. The phase angle may be set to 0 for the first carrier 302, the phase angle for the second carrier 304 may be between 120° and 180° and the phase angle for the third carrier 306 may be between 180° and 240° C.

At step/operation 512, the switch frequency may be set to fmax and the duty may be set to 0.5 for the first carrier 302, the second carrier 304, and/or the third carrier 306. The phase angle may be set to 0 for the first carrier 302, the phase angle for the second carrier 304 may be equal to 120° and the phase angle for the third carrier 306 may be equal to 240°.

At step/operation 514, the switch frequency may be decreased from fmax, while the duty remains at 0.5 for the first carrier 302, the second carrier 304, and/or the third carrier 306. The phase angle may be set to 0 for the first carrier 302, the phase angle for the second carrier 304 may be equal to 120°, and the phase angle for the third carrier 306 may be equal to 240°.

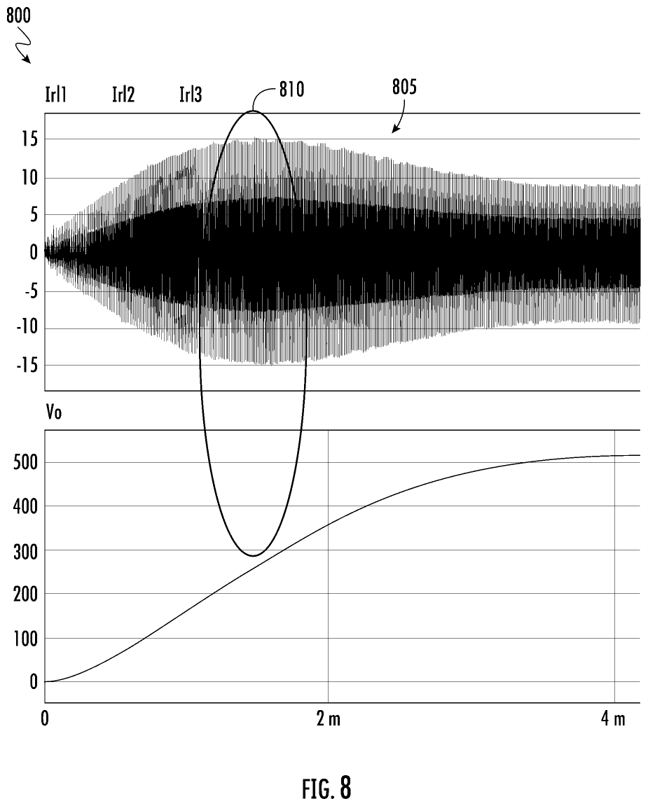

As shown, by modifying a phase angle of one or more carriers of the resonant converter, a soft start-up process may be implemented that reduces a maximum in-rush of current (e.g., a current spike) without modifying the duty of the resonant converter. As shown with reference to FIG. 8, some embodiments of the soft start-up process may significantly reduce current spike during start-up.

FIG. 8 illustrates an operational example 800 of a waveform during start-up of a resonant converter in accordance with one or more embodiments of the present disclosure. The operational example 800 illustrates a simulation waveform 805 of some example embodiments of the soft start-up techniques described herein. As shown by the simulation waveform 805, by using some embodiments of the techniques of the present disclosure, the maximum inrush of current 810 during start-up of an electrical charging device may be reduced to less than 15 amps, which is a significant improvement over traditional start-up techniques.

### CONCLUSION

Many modifications and other embodiments of the disclosures set forth herein will come to mind to one skilled in the art to which these disclosures pertain having the benefit of teachings presented in the foregoing descriptions and the associated drawings. Although the figures only show certain components of the apparatus and systems described herein, it is understood that various other components may be used in conjunction with the system. Therefore, it is to be understood that the disclosures are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. The disclosed embodiments relate primarily to fragmented wideband tympanometry techniques for true wireless stereo, however, one skilled in the art may recognize that such principles may be applied to any audio device. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the disclosure(s) set out in any claims that may issue from this disclosure.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While this detailed description has set forth some embodiments of the present disclosure, the appended claims cover other embodiments of the present disclosure which differ from the described embodiments according to various modifications and improvements. For example, the appended claims may cover any form of fragmented wideband tympanometry techniques as utilized with true wireless stereo and/or any other audio device.

Within the appended claims, unless the specific term “means for” or “step for” is used within a given claim.

1. A computing system comprising:
a three-phase LLC resonant converter, the three-phase LLC resonant converter comprising a first carrier, a second carrier, and a third carrier; and
a controller configured to:
initialize a switch frequency and a phase angle for each of the first carrier, the second carrier, and the third carrier;
increase a second carrier phase angle for the second carrier;
increase a third carrier phase angle for the third carrier;
in response to a detection of a phase threshold,
decrease the second carrier phase angle, and
increase the third carrier phase angle; and
in response to a detection of start-up phase criteria, reduce the switch frequency for the three-phase LLC resonant converter based on a target voltage.

2. The computing system of claim 1, wherein the three-phase LLC resonant converter is in a start-up control mode, and wherein the controller is further configured to:
monitor an output voltage of the three-phase LLC resonant converter; and
in response to the detection of the target voltage based on the output voltage, transition the three-phase LLC resonant converter to a closed-loop control mode.

3. The computing system of claim 1, wherein the controller is further configured to:
initialize a duty cycle to fifty percent for each of the first carrier, the second carrier, and the third carrier.

4. The computing system of claim 1, wherein initializing the switch frequency for each of the first carrier, the second carrier, and the third carrier comprises setting the switch frequency to a maximum operable frequency for the three-phase LLC resonant converter.

5. The computing system of claim 1, wherein initializing the phase angle for each of the first carrier, the second carrier, and the third carrier comprises:
initializing a first carrier phase angle for the first carrier to zero degrees;
initializing the second carrier phase angle for the second carrier to zero degrees; and
initializing the third carrier phase angle for the third carrier to zero degrees.

6. The computing system of claim 1, wherein:
increasing the second carrier phase angle for the second carrier comprises increasing the second carrier phase angle at a first rate of change, and
increasing the third carrier phase angle for the third carrier comprises increasing the third carrier phase angle at the first rate of change.

7. The computing system of claim 1, wherein:
decreasing the second carrier phase angle comprises decreasing the second carrier phase angle at a second rate of change, and
increasing the third carrier phase angle comprises increasing the third carrier phase angle at the second rate of change.

8. The computing system of claim 1, wherein the phase threshold is one hundred and eighty degrees, and wherein the controller is configured to:
monitor the second carrier phase angle and the third carrier phase angle; and
detect the phase threshold in response to the second carrier phase angle and the third carrier phase angle achieving the phase threshold.

9. The computing system of claim 1, wherein the start-up phase criteria comprises a low phase threshold and a high phase threshold, and wherein the controller is configured to:
monitor the second carrier phase angle and the third carrier phase angle; and
detect the start-up phase criteria in response to the second carrier phase angle achieving the low phase threshold and the third carrier phase angle achieving the high phase threshold.

10. The computing system of claim 9, wherein the low phase threshold is one hundred and twenty degrees and the high phase threshold is two hundred and forty degrees.

11. The computing system of claim 1, wherein the computing system comprises an electrical charging device configured to charge an external device and the target voltage is based on the external device.

12. The computing system of claim 11, wherein the external device is an electric vehicle battery.

13. The computing system of claim 12, wherein the target voltage is within a range of eight hundred and eight hundred and fifty volts.

14. An electric charging device comprising:
a three-phase LLC resonant converter, the three-phase LLC resonant converter comprising a first carrier, a second carrier, and a third carrier; and
a controller configured to:
initialize a switch frequency and a phase angle for each of the first carrier, the second carrier, and the third carrier;
increase a second carrier phase angle for the second carrier;
increase a third carrier phase angle for the third carrier;
in response to a detection of a phase threshold,
decrease the second carrier phase angle, and
increase the third carrier phase angle; and
in response to a detection of start-up phase criteria, reduce the switch frequency for the three-phase LLC resonant converter based on a target voltage.

15. The electric charging device of claim 14, wherein the electric charging device is an electric vehicle charging pile.

16. The electric charging device of claim 15, wherein the three-phase LLC resonant converter is configured to convert alternating current power to direct current power for charging a vehicle battery.

17. The electric charging device of claim 16, wherein the vehicle battery is configured to receive an output voltage of at least eight hundred volts.

18. A method comprising:
initializing a switch frequency and a phase angle for each of a first carrier, a second carrier, and a third carrier of a three-phase LLC resonant converter;
increasing a second carrier phase angle for the second carrier;
increasing a third carrier phase angle for the third carrier;
in response to a detection of a phase threshold,
decreasing the second carrier phase angle, and
increasing the third carrier phase angle; and
in response to a detection of start-up phase criteria, reducing the switch frequency for the three-phase LLC resonant converter based on a target voltage.

19. The method of claim 18 further comprising:
monitoring an output voltage of the three-phase LLC resonant converter;
detecting the target voltage based on the output voltage; and
in response to a detection of the target voltage, transitioning the three-phase LLC resonant converter from a start-up control mode to a closed-loop control mode.

20. The method of claim 19, wherein the target voltage is eight hundred volts.
